(19) United States
(12) Patent Application Publication
(10) Pub. No.: US 2004/0033609 A1
(43) Pub. Date: Feb. 19, 2004

(54) Catalyst testing method

(76) Inventors: Hai-Ying Chen, King of Prussia, PA (US); Paul J. Andersen, Plymouth Meeting, PA (US); Todd H. Ballinger, Audubon, PA (US)

Correspondence Address: RATNERPRESTIA, P O BOX 980, VALLEY FORGE, PA, 19482-0980, US

(21) Appl. No.: 10/217,802

(22) Filed: Aug. 13, 2002

(51) Int. Cl. G01N 31/10

(52) U.S. Cl. 436/37; 436/52; 436/137

(57) ABSTRACT

A method for testing a plurality of catalyst formulations and determining, from the plurality, a preferred catalyst formulation to be used in a catalyst device for treating a particular reactant stream is provided. The method comprises defining the cell characteristics of a catalyst device, providing a test monolith comprising a plurality of cell channels having cell characteristics equivalent to the cell characteristics of the catalyst device for which the preferred catalyst formulation is being determined, applying a plurality of different catalyst formulations on the cell channels of the test monolith, contacting a test reactant stream to all channels of the test monolith under flow conditions equivalent to the flow conditions under which the catalyst device is intended to be used, detecting comparative catalytic activity occurring at each formulation during said contacting step, and determining, from the detected activity, the preferred catalyst formulation for the catalyst device.

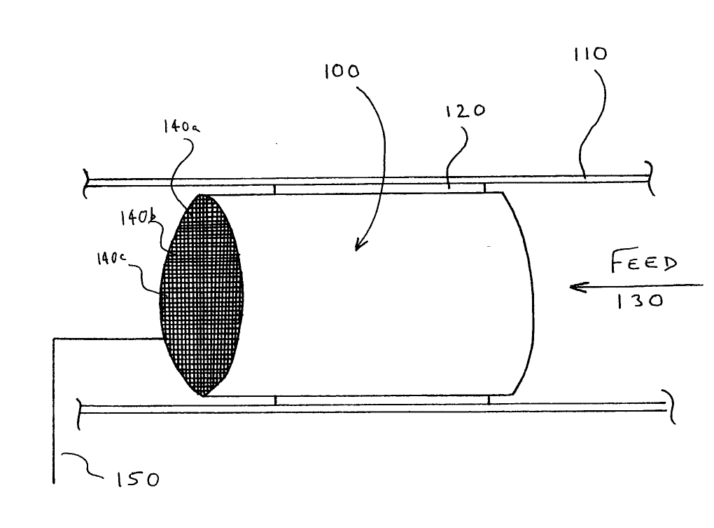

### FIELD OF THE INVENTION

The present invention relates generally to catalysts, and more specifically to a method for testing different catalyst formulations.

### BACKGROUND OF THE INVENTION

Catalyst testing has been accomplished by bench scale or large pilot plants in which a catalyst is contacted with a feed stream under reaction conditions and effluent products are sampled at the outlet. Often, the samples are analyzed and results are subjected to data resolution techniques to determine catalyst performance. Such procedures can take an undesirably long amount of time.

Combinatorial methods have been used in several industries, particularly the pharmaceutical industry, to synthesize and screen large numbers of organic compounds. This technique has lead to the development of combinatorial approaches to homogeneous and heterogeneous catalysis to accelerate the discovery of novel catalytic materials and catalytic processes.

At least one method has been developed in the prior art which permits the scanning of dozens of catalysts in a single set-up which allows catalyst testing in less time than conventional methods such as the one described briefly above. U.S. Pat. No. 6,063,633 discloses a multisample holder, such as a honeycomb or plate, which is treated with catalyst ingredients to fill wells or channels to produce a supported series of different catalyst combinations. The multisampled holder is then subjected to a feed stream or batch to catalyze reactions as desired by the tester. The reaction occurring in each cell is analyzed, and the analysis leads to a determination of the relative efficacy of each of the different catalysts tested.

This method is limited, however, to a relative determination of catalytic performance in a situation with gas flow rates, holding times, and mass diffusion situations which are defined by the testing apparatus. In other words, an accurate picture of the catalyst performance cannot be obtained using this method because a variety of variables exist (e.g. hold-up time, monolith volume, gas space velocity, pressure, mass diffusion of the reactants within the system, and gas composition, among other variables) for which no account is made. Moreover, this method only provides a picture of catalyst performance which is relative between those catalysts tested.

### SUMMARY OF THE INVENTION

The present invention includes a method for testing a plurality of catalyst formulations on the same type of device, and under the same type of conditions, for which the catalyst formulation chosen through the testing method will actually be used. This eliminates variables that could change between the testing apparatus and final application, such as mass diffusion differences and catalyst device residence times. The method allows the selection of the preferred catalyst formulation, chosen from among a plurality of catalyst formulations, to be used in a particular catalyst device for a particular reactant stream and under particular circumstances, all of which essentially match between the testing step and actual application.

The method comprises starting with a determination of the particular catalyst device to be used to treat the particular reactant stream. For example, it may be desired to use a monolith to treat an exhaust gas stream. The physical dimensions and cell characteristics of the monolith would be defined. The remaining variable, and the focus of this invention, would be the determination of the desired catalyst formulation. Thus, the method includes the step of providing a test monolith having physical properties equivalent to, or identical to, the final device which the tester wishes to employ in a particular application. A preferred embodiment includes the use of a monolith with cell channels disposed therethrough. The plurality of cell channels in the test device are essentially identical to the cell channels of the catalyst device for which the preferred catalyst formulation is being determined. Then, a plurality of different catalyst formulations are applied on the cell channels of the test monolith to generate an array of different catalyst formulation channels. That test device is then subjected to a test reactant stream to test the monolith under flow conditions equivalent to the flow conditions under which the catalyst device is intended to be used. The resultant streams from each cell channel are compared to determine catalytic activity occurring at each formulation. That comparison allows for the determination of the preferred catalyst formulation for the catalyst device.

### BRIEF DESCRIPTION OF THE DRAWING

The features of the invention believed to be novel and the elements characteristic of the invention are set forth with particularity in the appended claims. The FIGURE is for illustration purposes only and is not drawn to scale. The invention itself, however, both as to organization and method of operation, may best be understood by reference to the detailed description which follows taken in conjunction with the accompanying drawing in which the FIGURE is a schematic representation of a test device used in accordance with the method of the present invention.

### DETAILED DESCRIPTION OF THE INVENTION

The present invention includes the use of combinatorial methods on monolith catalysts to facilitate the determination of an optimum catalyst formulation for use in a desired reactant stream. More specifically, the invention provides a method to accurately determine the best catalyst formulation for a given reactant stream, which method takes into account variables such as cell channel residence time and mass transfer within the reactant stream so as to eliminate these uncertainties when applying the selected catalyst to a final product device. Thus, there is no need for additional experimentation, calculations or other adjustments to be made when designing and building the final catalytic device. Moreover, the present invention eliminates the uncertainty present with known methods for empirical determination of catalyst formulations by removing variables from the test procedure by using test conditions virtually identical to the environment for which the device is being designed.

The present invention is particularly well suited for use in designing exhaust gas catalytic devices (i.e. catalytic converters) for use in an exhaust gas system of an automotive vehicle. By using a test device having cell density and other characteristics equivalent to a final catalytic device intended to be used in a particular exhaust gas stream, and, if necessary, adjusting flow rate parameters so that variables such as cell residence time is the same between the test device and commercial device, the best catalyst formulation will be determined during the testing step. By standardizing these variables between the test device and commercial device, a true and accurate picture of the catalyst formulation performance will be gained and scale-up, if any, can be performed easily and with confidence that the proper catalyst formulation has been chosen. Moreover, the only difference between the test device and final commercial device is that the final commercial device would have the same catalyst formulation in all of its cell channels, as opposed to the test device which has a plurality of different catalyst formulation on different cell channels.

More specifically, the method comprises defining the cell characteristics of a catalyst device to be used to treat the particular reactant stream of interest. The cell characteristics include such things as cell density of the overall device, cross sectional area of each cell, cell wall thickness, length of each cell channel, etc. For example, the desired stream to be treated might be an exhaust gas stream from an internal combustion engine. In such a case, a monolith having known dimensions and a cell channel density of 400 cells per square inch may be desired. Thus, a test device comprised of these properties would be constructed.

Next, a plurality of different catalyst formulations would be selected by one skilled in the art, each of which is expected to demonstrate some degree of catalytic behavior on the known stream for which treatment is desired. In the case of the internal combustion engine exhaust gas stream application, for example, a stainless steel monolith might be treated with a three-way catalyst. Other known monolith materials could be used, such as alumina or cordierite.

For example, Al₂O₃-supported platinum (Pt) and rhodium (Rh) catalysts are well known three-way catalysts for the treatment of automotive emissions. Recent studies have suggested that there may be a synergistic effect between Pt and Rh when their relative concentrations fall within a certain narrow range. This narrow range might be the focus of this application of the present invention.

More specifically, in this example, a stainless steel monolith substrate could be wash-coated with Al₂O₃ using a known procedure and calcined. Two solutions of Pt and Rh would be prepared in two separate vessels. Different amounts of Pt would be impregnated onto each individual cell channel (or group of cell channels) by a commercially available pipette robot. The robot would dilute the Pt mother solution to desired concentration increments and deliver the diluted solutions to each cell channel (or group of cell channels). This creates an array of cell channels, each with a different Pt concentration. Then, the monolith sample would be calcined and the procedure would be repeated using the robot to add Rh. After final calcination, the test device is ready.

The test monolith would be loaded into a reactor and exposed to the exhaust gas directly from an engine or from a stream physically equivalent to an engine exhaust gas stream. The test stream would have the same properties which are important to the catalytic activity as the actual stream in which the final device will be used. The preferred embodiment of the invention uses the actual stream in which the final device will be used, but a synthesized or otherwise varied stream would suffice so long as the important characteristics such as composition, flow rate, temperature, holding time, etc. are the same. Because the test device has been constructed to have the same cell characteristics as the final device, and the test stream is operating under the same conditions as the stream in which the final device will be used, factors such as residence time and mass diffusion will be constant between the test scenario and final application.

The FIGURE shows test device 100 disposed within exhaust line 110. In this embodiment, test device 100 is held in place by mat 120. Feed stream 130 is passed through test device 100 and thus is contacted with the different cell channels 140a, 140b, 140c, etc., each of which has a slightly different catalyst formulation as described above. Capillary probe 150 is used to analyze the output of each cell channel as described in more detail below.

During testing, the activity of each catalyst formulation is monitored, preferably by detecting the products of the reactions using any suitable analytical device, such as a mass spectrometer or an optical spectrometer. Alternatively, the activity of the catalysts could be determined by the catalyst temperatures using temperature sensors such as thermocouples or infrared thermography. When a mass spectrometer is used, for example, a capillary probe is inset into a channel of the monolith catalyst to draw the outlet mixture into the mass spectrometer. Because of the small size of each channel, this would preferably be done by a robot according to known methods. Other analytical devices could also be used in conjunction with known automated (robotic) analytic devices.

In another example, palladium might be the catalyst of interest. In an example using palladium, the lower layer (adjacent the monolith) might be palladium intimately interacted with a stabilized CeO₂ oxygen storage component (OSC). The second, upper layer might be palladium separated from the OSC. Because it is known that CeO₂ can be stabilized by various metal ions and that the Ce content in the mixed oxides can be in a very wide range. It has also been realized that catalytic activity of the finished catalyst strongly depends on the oxide support materials used in both layers. In this example, therefore, one could investigate the effects of different OSC materials used in the lower layer while maintaining the same upper layer construction.

To do this, a series of slurries with different OSC materials are prepared, each of which is washcoated onto an individual cell channel (or group of cell channels) of a stainless steel monolith. After calcination, Pd solutions are impregnated onto each of the different OSC layers. If the washcoated OSC layers all have the same absorption of the Pd solution, one Pd solution can be added to all cell channels. If, on the other hand, the OSC layers have varying Pd solution absorptions, the Pd solutions will have to be adjusted accordingly. The idea is that the same amount of Pd be impregnated into each of the different OSC layers. The delivery of the Pd solution(s) is also preferably performed by a robot. The Pd solution impregnation is followed by calcination. Alternatively, a Pd salt may be added directly to the OSC slurries before the OSC slurries are even added to the monolith. After Pd-OSC layer preparation, a slurry with Pd prefixed on a non-OSC material is washcoated onto the Pd-OSC layer and this is calcined. The result is a monolith having many cell channels (or many groups of cell channels), each of which has a different Pd-OSC lower layer and constant Pd-non-OSC upper layer. Testing proceeds the same as that described above.

In yet another example, one can study the effects of different non-OSC materials in the upper layer while holding the lower, OSC material, constant. To do this, a slurry of an OSC material is prepared and washcoated onto a monolith and then calcined. After calcination, a Pd solution is impregnated. As noted above, the Pd could be added directly to the slurry before washcoating, thus eliminating the impregnation step. In any event, the lower level is established such that all cell channels have the same OSC composition. Then, a series of different slurries of non-OSC materials can be prepared. In this example, Pd can be prefixed onto the non-OSC lower layer either by impregnation, precipitation, or chemical reduction. These slurries, with different Pd concentrations, are then applied and calcined. The result is a test monolith having cell channels with differing upper Pd-non-OSC layers and testing proceeds.

Testing of the test monolith involves contacting a test reactant stream to all channels of the test monolith under flow conditions equivalent to the flow conditions under which the catalyst device is intended to be used. This equivalency includes both test stream composition and condition. Thus, the test stream must have the same compositional makeup and be under the same conditions such as temperature and pressure. It is important that factors impacting the catalytic performance of the different catalyst formulation be consistent with the environment in which the catalyst device will be used. Otherwise, variables such as mass diffusion and residence time will change between the test device and final device. If such differences are allowed to exist, the behavior of the catalyst device which is built using test device data will differ.

Preferably, the test device and final device intended for use will have identical physical characteristics, including cell density, materials of construction, length, cross sectional area, etc. Simple modifications, however, are contemplated, such as using a one square inch cross sectional test device, even if the final device might have a cross sectional area of 15 square inches. In such a case, however, the cell channel density would still have to be the same (perhaps 400 square inches) in both cases. In order to accommodate the smaller test device cross sectional area, however, an appropriate reduction in reactant gas stream flow rate would have to be made. If such a reduction was not made, the flow rates in each individual channel would be different between the two devices. The key is that the test device and conditions under which testing is performed be equivalent, or even identical, to the conditions under which actual use of the selected catalyst formulation will occur. This aspect of the present invention eliminates the need for scale-up or other variations to be accounted for before the final device can be made. It also insures equivalent performance of the selected catalyst material in the final device, consistent with the data generated during testing.

During the testing step of the method, comparative catalytic activity occurring at each formulation during the contacting step is measured and analyzed consistent with the methods described above. From this information, the preferred catalyst formulation is determined. All that is left at that point is to prepare a final catalyst device which is constructed identical to the test device. If, as discussed above, cross sectional area or other accountable variables are involved, appropriate changes would be incorporated. The idea is that the final device differs from the test device only in that the final device has all of its channels (which are otherwise the same) coated with the same composition(s) as the preferred cell channel of the test device.

Accordingly, while illustrated and described herein with reference to certain specific embodiments, the present invention is not intended to be limited to the embodiments and details shown. Rather, the appended claims are intended to include all embodiments and modifications which may be made in these embodiments and details, which are nevertheless within the true spirit and scope of the present invention.

What is claimed:

1. A method for testing a plurality of catalyst formulations and determining, from the plurality, a preferred catalyst formulation to be used in a catalyst device for treating a particular reactant stream, said method comprising:
defining the cell characteristics of the catalyst device to be used to treat the particular reactant stream;
providing a test monolith comprising a plurality of cell channels having cell characteristics equivalent to the cell characteristics of the catalyst device for which the preferred catalyst formulation is being determined;
applying a plurality of different catalyst formulations on the cell channels of the test monolith to generate an array of different catalyst formulation channels;
contacting a test reactant stream to the cell channels of the test monolith under flow conditions equivalent to the flow conditions under which the catalyst device is intended to be used, wherein the test reactant stream is equivalent to the particular reactant stream with which the catalyst device is intended to be used;
detecting comparative catalytic activity occurring at each formulation during said contacting step; and
determining, from the detected activity, the preferred catalyst formulation for the catalyst device.

2. The method of claim 1 further comprising the step of defining, before said applying step, a plurality of possible catalyst formulations based on the composition of the reactant stream for which catalysis is desired.

3. The method of claim 1 wherein the reactant stream is an exhaust gas stream from an engine of an automotive vehicle and the catalytic device is a catalytic converter of an exhaust system of an automotive vehicle.

4. A method for providing an exhaust gas catalytic device comprising the steps of:
(a) testing a plurality of catalyst formulations to determine comparative catalytic activity of the formulations in the presence of an exhaust gas stream, said testing step comprising:
defining the cell characteristics of a catalyst device to be used to treat the exhaust gasstream;
providing a test monolith comprising a plurality of cell channels having cell characteristics equivalent to the cell characteristics of the catalyst device for which the preferred catalyst formulation is being determined;
applying the plurality of different catalyst formulations on the cell channels of the test monolith to generate an array of different catalyst formulation channels;
contacting a test reactant stream to all channels of the test monolith under flow conditions equivalent to the flow conditions under which the catalyst device is intended to be used, wherein the test reactant stream is equivalent to the exhaust gas stream with which the catalyst device is intended to be used; and
detecting comparative catalytic activity occurring at each formulation during said contacting step;
(b) selecting one of the plurality of catalyst formulations based on said detecting step; and
(c) providing an exhaust gas catalytic device comprising a second monolith essentially identical to the test monolith provided in said providing step of step (a), wherein the second monolith is coated in all channels with the one of the plurality of catalyst formulations selected in step (b).
